(19) United States
(12) Patent Application Publication
(10) Pub. No.: US 2008/0012822 A1
(43) Pub. Date: Jan. 17, 2008

(54) Motion Browser

(76) Inventor: Ketul Sakhpara, Plano, TX (US)

Correspondence Address: CONLEY ROSE, P.C., 5601 GRANITE PARKWAY, SUITE 750, PLANO, TX, 75024, US

(21) Appl. No.: 11/456,618

(22) Filed: Jul. 11, 2006

(51) Int. Cl. G09G 5/00

(52) U.S. Cl. 345/156

(57) ABSTRACT

A system for causing an action on a display of a handset is provided. The system consists of a motion sensor, an interface controller, and an activation mechanism. The motion sensor is operable to detect a movement of the handset. The interface controller is operable to promote the movement detected by the motion sensor being translated to action on the display of the handset. The activation mechanism is operable, when activated, to promote the interface controller translating movement of the handset to action on the display.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Handheld electronic devices such as personal digital assistants, handheld computers, mobile telephones, and similar devices often include a display screen on which a user can view web pages, read text, or gain access to other information presented in a visual medium. Browsing through the information displayed on such devices can be difficult. For example, to scroll upward or downward through a web page, a user might need to repeatedly press an up key or down key on the keypad of the device. Repeated pressing of the small keys typically present on such devices can be tedious and error prone.

### SUMMARY

In one embodiment, a system for causing an action on a display of a handset is provided. The system consists of a motion sensor, an interface controller, and an activation mechanism. The motion sensor is operable to detect a movement of the handset. The interface controller is operable to promote movement detected by the motion sensor being translated to action on the display of the handset. The activation mechanism is operable, when activated, to promote the interface controller translating movement of the handset to actions on the display.

In another embodiment, a method for causing an action on a display of a handset is provided. The method consists of activating an activation mechanism on the handset, moving the handset, detecting movement of the handset, and causing action on the display related to the movement.

In another embodiment, a handset is provided. The handset consists of a motion sensor, an interface controller, and an activation mechanism. The motion sensor is operable to detect a movement of the handset. The interface controller is operable to promote movement of the handset being used to navigate an electronic document on a display on the handset. The activation mechanism is operable, when activated, for the movement to be used to navigate the electronic document on the display on the handset.

These and other features and advantages will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a diagram of a mobile device operable for some of the various embodiments of the disclosure.

FIG. 2 is a diagram of a method for causing an action on a display of a handset according to an embodiment of the disclosure.

FIG. 3 is a diagram of a wireless communications system including a mobile device operable for some of the various embodiments of the present disclosure.

FIG. 4 is a block diagram of a mobile device operable for some of the various embodiments of the present disclosure.

FIG. 5 is a block diagram of a software environment that may be implemented by a mobile device operable for some of the various embodiments of the present disclosure.

### DETAILED DESCRIPTION

It should be understood at the outset that although an illustrative implementation of one embodiment of the present disclosure is illustrated below, the present system may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

Embodiments of the present disclosure provide a system and method for movement through the display screen on a personal digital assistant, handheld computer, wireless or mobile telephone or handset, or similar device. Such devices may be referred to herein as handsets. In an embodiment, a handset includes a motion sensor that can detect movement of the handset. The motion sensor sends information about the handset's movement to an interface controller. The interface controller then causes a movement or navigation through the display screen of the handset that corresponds to the movement of the handset. The handset might be equipped with a button or similar mechanism that can activate the motion sensing and corresponding movement through the display. For example, when the button is pressed, up and down movement of the handset might cause up and down scrolling through a web page. When the button is not pressed, the handset's motion does not cause any action in the display.

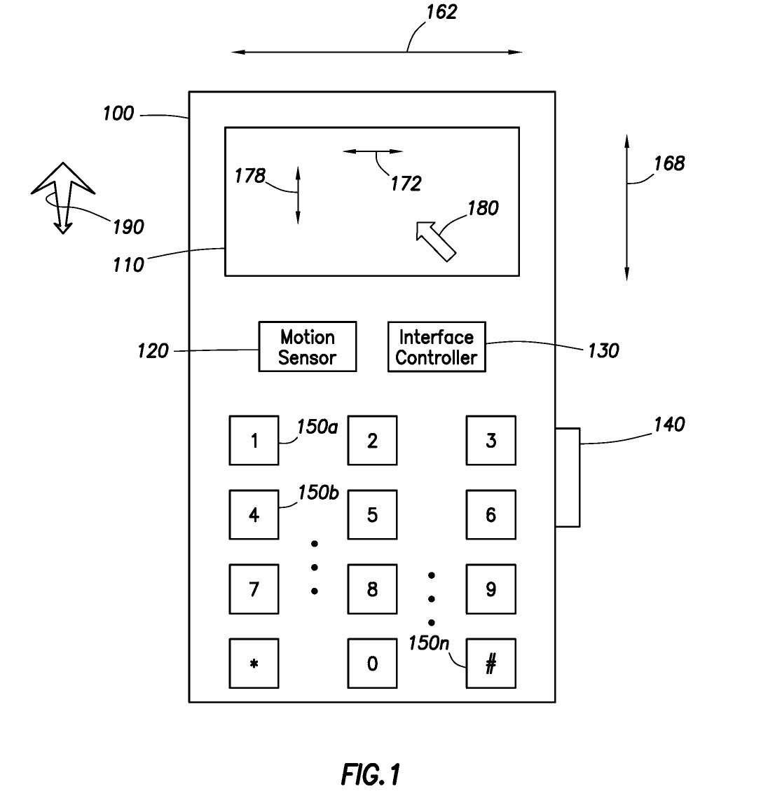

FIG. 1 illustrates an embodiment of a handset 100 capable of converting movement of the handset 100 to browsing, scrolling, pointing, or a similar action. The handset 100 includes a display screen 110, a motion sensor 120, an interface controller 130, and an activation button 140. Other buttons 150 typically found on a handset 100, such as numeric keypad buttons, alphabetic keyboard buttons, and/or cursor control buttons might also be present.

The motion sensor 120 might include an accelerometer or some other known mechanism for detecting movement. The motion sensor 120 can determine the direction and speed of the motion of the handset 100 and can send that information to the interface controller 130. The interface controller 130 can convert the information received from the motion sensor 120 into an action that occurs on the screen 110. For example, movement of the handset 100 in a horizontal direction 162 might cause a movement through a web page or a text document in a horizontal direction 172 on the screen 110. Movement of the handset 100 in a vertical direction 168 might cause a movement in a vertical direction 178 on the screen 110.

The activation button 140 controls whether or not movement of the handset 100 causes an action in the screen 110. When the activation button 140 is activated, for example, when the button 140 is depressed, the motion sensor 120 collects information about the movement of the handset 100 and the interface controller 130 uses that information to cause an action on the screen 110. When the activation button 140 is not depressed, or is otherwise inactivated, movement of the handset 100 does not cause an action on the screen 110. While the activation button 140 is depicted on the side of the handset 100, in other embodiments the activation button 140 could be in other locations. Also, activation mechanisms other than a button 140 could be used.

The action that occurs on the screen 110 when the handset 100 is moved while the activation button 140 is depressed would typically be a scrolling motion through the screen 110 or a movement of a pointer through the screen 110. For example, if a web page or a text document is displayed on the screen 110, the handset 100 could be moved in such a manner that an up/down or left/right scrolling through the web page or document occurs. Alternatively, movement of the handset 1.00 could be used to move a pointer 180 through the screen 110 in a manner similar to the movement of a mouse pointer on a computer screen by means of a mouse. The pointer 180 could be moved in such a manner that it points to a desired location on the screen 110 and makes the data at the location available for selection. Movement of the handset 100 might also cause different portions of an image, such as a map, to move about or be displayed on the screen 110. Any of these types of actions might be referred to as navigation through the screen 110.

In an embodiment, the activation button 140 might be capable of being placed in a plurality of positions, each of which might cause a different type of action on the screen 110 when the handset 100 is moved. For example, the activation button 140 might be a multi-position switch such as a rocker-type switch. The rocker switch might cause a scrolling action when tilted in a first direction and might cause a pointer movement when tilted in a second direction. One of skill in the art will recognize other types of activation mechanisms that could allow the selection of different types of action on the screen 110.

Alternatively, the handset 100 might include a plurality of activation buttons 140, each of which causes a different type of action. For example, a first activation button might cause a scrolling action when it is depressed while the handset 100 is moved, a second activation button might cause a pointer movement when it is depressed while the handset 100 is moved, and a third activation button might cause yet another type of action when it is depressed while the handset 100 is moved. In yet another alternative, a standard button 150 or other input mechanism on the handset 100 might be used to select the type of action that will occur and the activation button 140 might be used to activate the selected action.

When movement of the handset 100 is used to control movement of the pointer 180, selection of the text or other data at the location at which the pointer 180 is pointing can be accomplished in several different manners. That is, there may be several different ways of carrying out an action that would be carried out through a mouse click on a typical desktop computer. In an embodiment, the activation button 140 might be a multi-position button or switch that can be placed in a position that causes the desired selection. In an alternative embodiment, an additional button might be added to the handset 100 to allow the selection, or a particular movement or motion of the handset could signal the selection. In yet another alternative, one of the buttons 150 or another input mechanism that is typically present on a standard handset could be used to make the selection.

In an embodiment, the speed at which the handset 100 is moved while the activation button 140 is depressed controls the speed at which an action occurs in the screen 110. For example, a quick movement of the handset 100 in the vertical direction 168 might cause a quick up or down scrolling through a web page or text document. A slower vertical movement of the handset 1.00 might cause a slower up or down scrolling. Similarly, the speed at which the handset 100 is moved might control the speed at which the pointer 180 moves.

While the previous discussion has focused only on the horizontal 162 and vertical 168 directions for scrolling or pointer movement, it should be clear that movement at other angles is also possible. For pointer movement, in particular, it is desirable that the pointer 180 have the capability to move freely about the screen 110 in any direction. In an embodiment, the motion sensor 120 is capable of detecting motion in any combination of horizontal and vertical vectors and the interface controller 130 is capable of converting these motions into scrolling movement or movement of the pointer 180 in the corresponding directions. This may be particularly useful when graphical images are on display in the screen 110. For example, a user might move the handset 100 in the appropriate directions to cause a desired portion of a map to appear in the screen 110.

Actions on the screen 110 might also be caused by movement of the handset 100 in an up and down direction. That is, moving the handset 100 in a direction 190 along a “Z” axis that is perpendicular to the plane of the screen 110 might cause actions to occur in the screen 110. In one embodiment, movement in this direction 190 might cause a zooming in and a zooming out of the information in the screen 110. In another embodiment, movement in this third dimension, or direction 190, might be done when a web browser is in use on the handset 100 and might cause forward and backward navigation through a series of recently visited web pages. That is, moving in a first direction, such as down, in the third dimension or direction 190 might be equivalent to clicking a “back” button in a standard web browser and moving up in the direction 190 might be equivalent to clicking a “forward” button in a standard web browser. Other movement or combinations of movements of the handset might be associated with navigational or other functionality of handset applications.

It should be understood that, as with motion in the horizontal 162 and vertical 168 directions, actions may occur on the screen 110 upon motion in the direction 190 only when the activation button 140 is activated. Also, it should be clear that motion in the direction 190 does not necessarily need to be exactly along the direction 190 or “Z” axis. The motion sensor 120 can detect combinations of horizontal, vertical, and “Z” axis motion and the interface controller 130 can cause the appropriate corresponding actions in the screen 110.

Various applications might be capable of making use of the motion of the handset 100. As examples, a web browser might interpret an input from the interface controller 130 as a command for scrolling through a single web page or for navigating among several web pages. A word processing program might interpret an input from the interface controller 130 as a command for scrolling through a text document, placing a cursor at a selected point within a text document, or navigating through a file directory. A mapping program might interpret an input from the interface controller 130 as a command for navigating a map on the screen 110 or for zooming in and out of the map. An email program might interpret an input from the interface controller 130 as a command for scrolling through a single email message or for navigating among several email messages. Furthermore, alternative movements or motions of the handset may be associated with other application functionality and/or actions, all of which will be evident to one of skill in the art.

In an embodiment, a single interface controller 130 is capable of providing input to a plurality of different applications. In an alternative embodiment, a plurality of interface controllers 130 may be present in the handset 100 and each may be capable of providing input to one or more different applications.

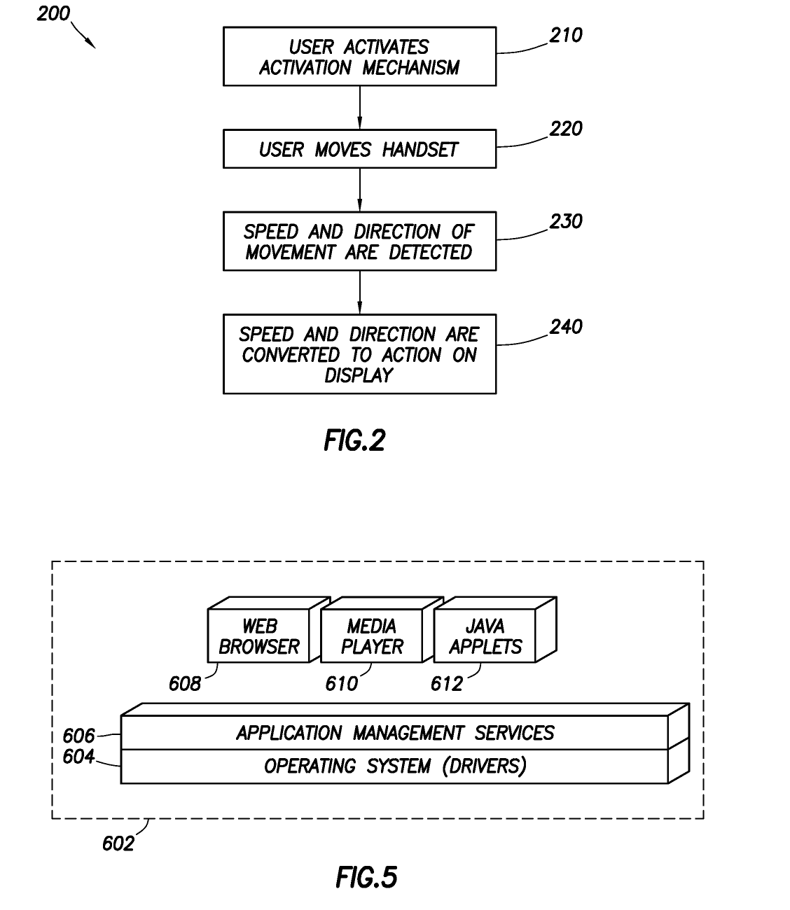

FIG. 2 illustrates a method 200 for causing an action on a display on a handset. In box 210, a user activates an activation mechanism on the handset. The activation mechanism might be a push button and activating the activation mechanism might consist of depressing the push button. In box 220, the user moves the handset while the activation mechanism is activated. In box 230, the speed and direction of the movement are detected. In box 240, the speed and direction of movement are converted to the action. The action might consist of a scrolling motion through text or other information on the display or might consist of movement of a pointer through the display.

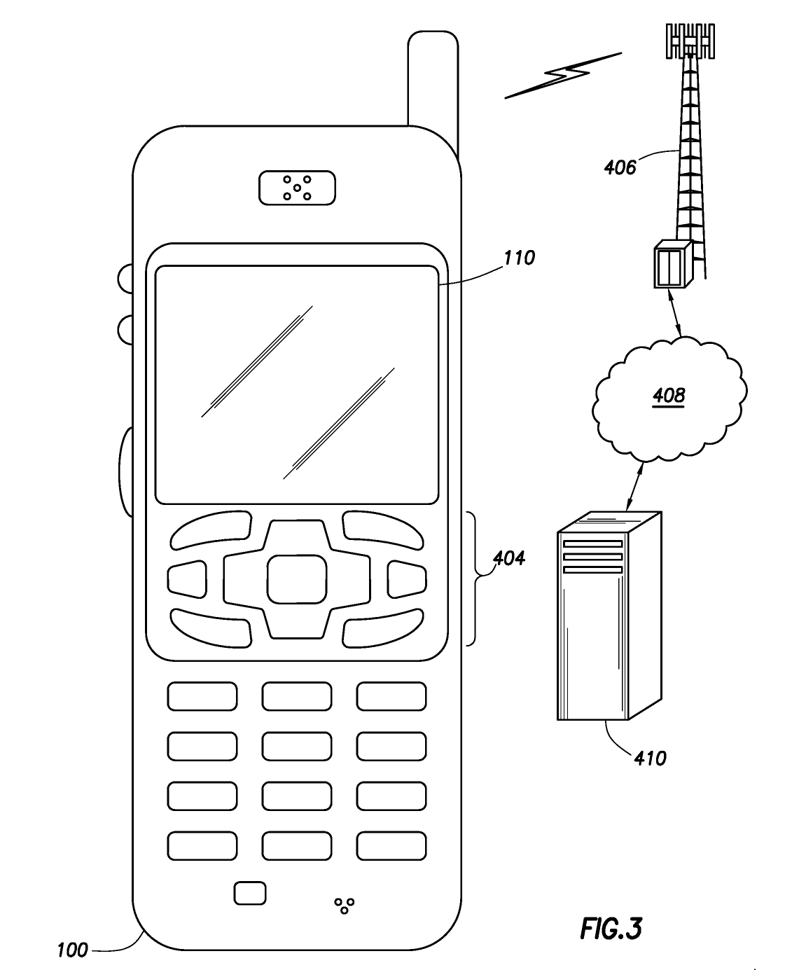

FIG. 3 shows a wireless communications system including the handset 100. FIG. 3 depicts the handset 100, which is operable for implementing aspects of the present disclosure, but the present disclosure should not be limited to these implementations. Though illustrated as a mobile phone, the handset 100 may take various forms including a wireless handset, a pager, a personal digital assistant (PDA), a portable computer, a tablet computer, or a laptop computer. Many suitable handsets combine some or all of these functions. In some embodiments of the present disclosure, the handset 100 is not a general purpose computing device like a portable, laptop or tablet computer, but rather is a special-purpose communications device such as a mobile phone, wireless handset, pager, or PDA.

The handset 100 includes a display 110 and a touch-sensitive surface or keys 404 for input by a user. The handset 100 may present options for the user to select, controls for the user to actuate, and/or cursors or other indicators for the user to direct. The handset 100 may further accept data entry from the user, including numbers to dial or various parameter values for configuring the operation of the handset 100. The handset 100 may further execute one or more software or firmware applications in response to user commands. These applications may configure the handset 100 to perform various customized functions in response to user interaction.

Among the various applications executable by the handset 100 are a web browser, which enables the display 110 to show a web page. The web page is obtained via wireless communications with a cell tower 406, a wireless network access node, or any other wireless communication network or system. The cell tower 406 (or wireless network access node) is coupled to a wired network 408, such as the Internet. Via the wireless link and the wired network, the handset 100 has access to information on various servers, such as a server 410. The server 410 may provide content that may be shown on the display 110.

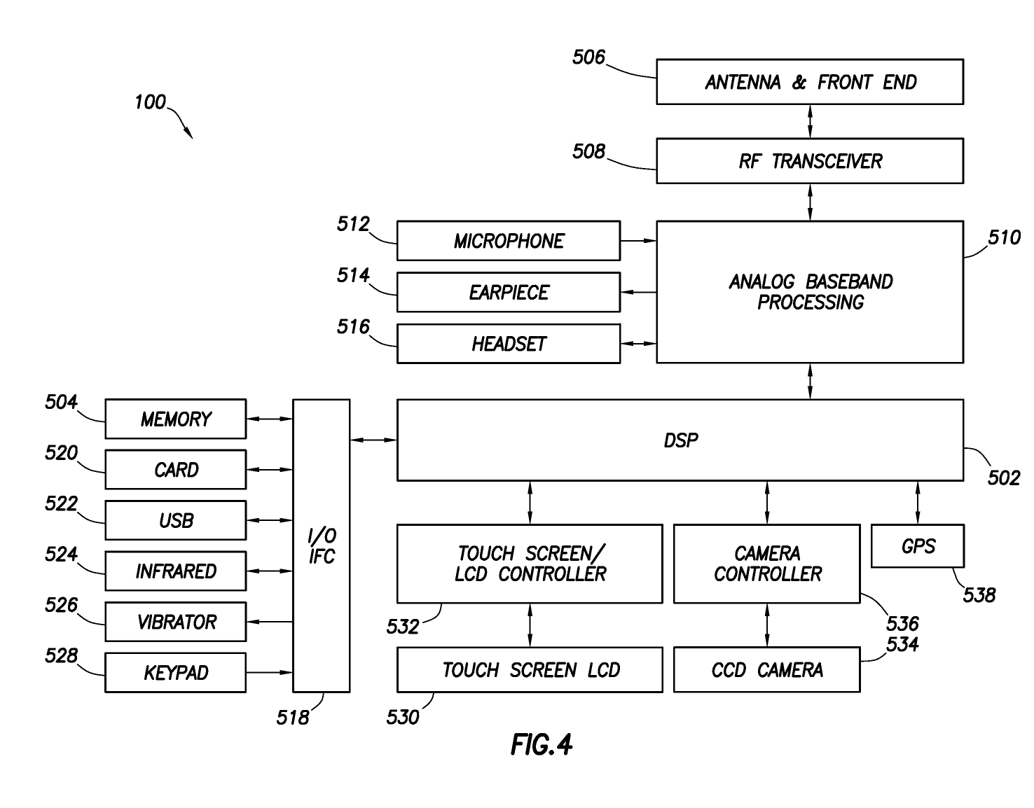

FIG. 4 shows a block diagram of the handset 100. The handset 100 includes a digital signal processor (DSP) 502 and a memory 504. As shown, the handset 100 may further include an antenna and front end unit 506, a radio frequency (RF) transceiver 508, an analog baseband processing unit 510, a microphone 512, an earpiece speaker 514, a headset port 516, an input/output interface 518, a removable memory card 520, a universal serial bus (USB) port 522, an infrared port 524, a vibrator 526, a keypad 528, a touch screen liquid crystal display (LCD) with a touch sensitive surface 530, a touch screen/LCD controller 532, a charge-coupled device (CCD) camera 534, a camera controller 536, and a global positioning system (GPS) sensor 538.

The DSP 502 or some other form of controller or central processing unit operates to control the various components of the handset 100 in accordance with embedded software or firmware stored in memory 504. In addition to the embedded software or firmware, the DSP 502 may execute other applications stored in the memory 504 or made available via information carrier media such as portable data storage media like the removable memory card 520 or via wired or wireless network communications. The application software may comprise a compiled set of machine-readable instructions that configure the DSP 502 to provide the desired functionality, or the application software may be high-level software instructions to be processed by an interpreter or compiler to indirectly configure the DSP 502.

The antenna and front end unit 506 may be provided to convert between wireless signals and electrical signals, enabling the handset 100 to send and receive information from a cellular network or some other available wireless communications network. The RF transceiver 508 provides frequency shifting, converting received RF signals to baseband and converting baseband transmit signals to RF. The analog baseband processing unit 510 may provide channel equalization and signal demodulation to extract information from received signals, may modulate information to create transmit signals, and may provide analog filtering for audio signals. To that end, the analog baseband processing unit 510 may have ports for connecting to the built-in microphone 512 and the earpiece speaker 514 that enable the handset 100 to be used as a cell phone. The analog baseband processing unit 510 may further include a port for connecting to a headset or other hands-free microphone and speaker configuration.

The DSP 502 may send and receive digital communications with a wireless network via the analog baseband processing unit 510. In some embodiments, these digital communications may provide Internet connectivity, enabling a user to gain access to content on the Internet and to send and receive e-mail or text messages. The input/output interface 518 interconnects the DSP 502 and various memories and interfaces. The memory 504 and the removable memory card 520 may provide software and data to configure the operation of the DSP 502. Among the interfaces may be the USB interface 522 and the infrared port 524. The USB interface 522 may enable the handset 100 to function as a peripheral device to exchange information with a personal computer or other computer system. The infrared port 524 and other optional ports such as a Bluetooth interface or an IEEE 802.11 compliant wireless interface may enable the handset 100 to communicate wirelessly with other nearby handsets and/or wireless base stations.

The input/output interface 518 may further connect the DSP 502 to the vibrator 526 that, when triggered, causes the handset 100 to vibrate. The vibrator 526 may serve as a mechanism for silently alerting the user to any of various events such as an incoming call, a new text message, and an appointment reminder.

The keypad 528 couples to the DSP 502 via the interface 518 to provide one mechanism for the user to make selections, enter information, and otherwise provide input to the handset 100. Another input mechanism may be the touch screen LCD 530, which may also display text and/or graphics to the user. The touch screen LCD controller 532 couples the DSP 502 to the touch screen LCD 530.

The CCD camera 534 enables the handset 0100 to take digital pictures. The DSP 502 communicates with the CCD camera 534 via the camera controller 536. The GPS sensor 538 is coupled to the DSP 502 to decode global positioning system signals, thereby enabling the handset 100 to determine its position. Various other peripherals may also be included to provide additional functions, e.g., radio and television reception.

FIG. 5 illustrates a software environment 602 that may be implemented by the DSP 502. The DSP 502 executes operating system drivers 604 that provide a platform from which the rest of the software operates. The operating system drivers 604 provide drivers for the handset hardware with standardized interfaces that are accessible to application software. The operating system drivers 604 include application management services (“AMS”) 606 that transfer control between applications running on the handset 100. Also shown in FIG. 5 are a web browser application 608, a media player application 610, and Java applets 612. The web browser application 608 configures the handset 100 to operate as a web browser, allowing a user to enter information into forms and select links to retrieve and view web pages. The media player application 610 configures the handset 100 to retrieve and play audio or audiovisual media. The Java applets 612 configure the handset 100 to provide games, utilities, and other functionality.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A system for causing an action on a display of a handset comprising:
a motion sensor operable to detect a movement of the handset;
an interface controller operable to promote movement detected by the motion sensor being translated to action on the display of the handset; and
an activation mechanism operable, when activated, to promote the interface controller translating movement of the handset to action on the display.

2. The system of claim 1, wherein the action is at least one of:
a scrolling through information on the display; and
a movement of a pointer through the display.

3. The system of claim 2, wherein the activation mechanism is a switch coupled to the handset and having a plurality of positions, each position causing a different action on the display when the handset is moved.

4. The system of claim 2, wherein the activation mechanism is a plurality of mechanisms, each mechanism causing a different action on the display when the handset is moved.

5. The system of claim 2, further comprising a mechanism for selecting a data item to which the pointer points.

6. The system of claim 2, wherein a movement of the handset in a direction substantially perpendicular to a plane of a surface of the display causes at least one of:
a zooming in of the information on the display;
a zooming out of the information on the display; and
a navigation through a series of web pages previously displayed on the display.

7. The system of claim 2, wherein the display is operable to display at least one of:
a web browser;
a word processor;
an image viewer; and
an email client.

8. A method for causing an action on a display of a handset comprising:
activating an activation mechanism on the handset;
moving the handset;
detecting movement of the handset; and
causing action on the display related to the movement.

9. The method of claim 8, wherein the action is at least one of:
a scrolling through information on the display; and
a movement of a pointer through the display.

10. The method of claim 9, wherein detecting the movement of the handset and causing the action on the display further includes:
detecting a speed and a direction of the moving of the handset; and
the action on the display related to the speed and the direction of the movement of the handset.

11. The method of claim 10, wherein activating the activation mechanism promotes detection of the speed and the direction of the movement of the handset and promotes converting the speed and the direction to the action, and wherein deactivating the activation mechanism causes the moving of the handset not to be translated into action on the display.

12. The method of claim 10, wherein the activation mechanism is at least one of:
a switch operable to be placed in a plurality of positions, each position causing a different action on the display when the handset is moved; and
a plurality of mechanisms, each mechanism causing a different action on the display when the handset is moved.

13. The method of claim 10, wherein moving the handset horizontally and vertically causes related horizontal and vertical movement on the display, and wherein moving the handset in a direction substantially perpendicular to a plane of a surface of the display causes at least one of:
zooming in on the information on the display;
zooming out of the information on the display; and
navigating through a series of web pages previously displayed on the display.

14. The method of claim 10, wherein the display is operable to display at least one of:
a web browser;
a word processor;
an image viewer; and
an email client.

15. A handset comprising:
a motion sensor to detect a movement of the handset;
an interface controller to promote movement of the handset being used to navigate an electronic document on a display on the handset; and
an activation mechanism, when activated, to promote the operability of the interface controller.

16. The handset of claim 15, wherein the navigating the electronic document includes one of:
a scrolling through information on the display; and
a movement of a pointer through the display.

17. The handset of claim 16, wherein the activation mechanism is at least one of:
a switch operable to be placed in a plurality of positions, each position causing a different action on the display when the handset is moved; and
a plurality of mechanisms, each mechanism causing a different action on the display when the handset is moved.

18. The handset of claim 17, wherein the motion sensor is further operable to detect a speed of the movement of the handset, the interface controller using the speed as a component of the navigation of the electronic document.

19. The handset of claim 18, wherein a movement of the handset in a direction substantially perpendicular to a plane of a surface of the display causes at least one of:
a zooming in of the information on the display;
a zooming out of the information on the display; and
a navigation through a series of web pages previously displayed on the display.

20. The handset of claim 19, wherein the display is operable to display at least one of:
a web browser;
a word processor;
an image viewer; and
an email client.
